(19) United States
(12) Patent Application Publication
(10) Pub. No.: US 2012/0308874 A1
(43) Pub. Date: Dec. 6, 2012

(54) SECONDARY BATTERY AND BATTERY PACK

(76) Inventors: Takuya OOTANI, Osaka (JP); Hiroshi Okamoto, Osaka (JP); Yuki Watanabe, Osaka (JP); Kazuya Sakashita, Osaka (JP); Tadashi Nemoto, Osaka (JP)

(21) Appl. No.: 13/487,392

(22) Filed: Jun. 4, 2012

(30) Foreign Application Priority Data
Jun. 3, 2011 (JP) 2011-124882

(51) Int. Cl. H01M 2/02; H01M 2/04; H01M 10/04; H01M 2/30

(52) U.S. Cl. 429/159; 429/179

(57) ABSTRACT

Provided are a secondary battery and a battery pack, in which when a plurality of secondary batteries having a laminated electrode assembly are stacked to constitute the battery pack, deformation of each secondary battery can be suppressed, electrode assemblies are not shifted, and no breakage occurs in terminals, even if an external force such as vibration is applied. For this purpose, a secondary battery (RB) includes anti-displacement members disposed inside and outside of the lid member (12) so as to be symmetric with respect to a surface of the lid member (12), so that secondary batteries are formed. Then, the secondary batteries are stacked and housed as a unit in a battery pack casing (CA), and a fixing means for uniformly pressing the same position in the stack direction so as to press and fix all the secondary batteries as a unit, so that a battery pack (M1) is formed.

### CROSS-REFERENCE TO RELATED APPLICATIONS

This application is based on Japanese Patent Application No. 2011-124882 filed on Jun. 3, 2011, the contents of which are hereby incorporated by reference.

### BACKGROUND OF THE INVENTION

1. Field of the Invention

The present invention relates to a secondary battery including a laminated electrode assembly in which positive electrode plates and negative electrode plates are laminated alternately, and to a battery pack in which a plurality of the secondary batteries are connected.

2. Description of Related Art

Recent years, a lithium secondary battery is used as power supply battery of a portable electronics device such as a mobile phone or a notebook personal computer, because it has high energy density and can realize a small size and lightweight. In addition, because the lithium secondary battery can support large capacity, it has been noted as a motor drive power source for an electric vehicle (EV) or a hybrid electric vehicle (HEV), or as a storage battery for storing electric power.

The lithium secondary battery has a structure including an encapsulating case constituting a battery can, an electrode assembly housed in the encapsulating case, in which a positive electrode plate and a negative electrode plate are opposed via a separator, electrolytic solution filled in the encapsulating case, a positive electrode collector terminal connected to positive electrode collector tabs of a plurality of positive electrode plates, a positive electrode external terminal connected electrically to the positive electrode collector terminal, a negative electrode collector terminal connected to negative electrode collector tabs of a plurality of negative electrode plates, and a negative electrode external terminal connected electrically to the negative electrode collector terminal.

In addition, it has been studied to connect a plurality of such lithium secondary batteries to use as an electric power source for a large power. For instance, a battery pack having a structure in which single batteries constituted of a secondary battery including a laminated electrode assembly are stacked vertically is already proposed (see, for example, Patent Document 1: JP-A-2003-288883).

In the lithium secondary battery including the laminated electrode assembly, the electrode assembly including the positive electrode plates and the negative electrode plates laminated via separators to form a plurality of layers is housed in the encapsulating case, and nonaqueous electrolytic solution is filled in the encapsulating case. There are provided the positive electrode collector terminal connected to the positive electrode collector tabs of the individual positive electrode plates, the external terminal connected electrically to the positive electrode collector terminal, the negative electrode collector terminal connected to the negative electrode collector tabs of the negative electrode plates, and the external terminal connected electrically to the negative electrode collector terminal.

In order to achieve a large capacity of the lithium secondary battery having the above-mentioned structure, it is necessary to increase areas of the positive electrode plate and the negative electrode plate, to increase the number of laminated layers, and to increase amount of the electrolytic solution. For this purpose, the single battery including the laminated electrode assembly is manufactured to have a large surface area and a large thickness.

In the laminated lithium secondary battery, if a space between the laminated positive electrode plate and negative electrode plate is increased when the battery can is expanded due to gas generated inside the battery can, internal resistance may be increased so that battery capacity may be decreased. Further, in addition to deformation of the battery can of each secondary battery (single battery), if the structure of the stacked battery pack is shifted or deformed, connection terminal portions connecting the battery cans are deformed or broken so that desired battery capacity cannot be generated.

In other words, when a battery pack is constituted by stacking a plurality of secondary batteries including the laminated electrode assembly, it is necessary to suppress expansion of each secondary battery and to securely fix the plurality of secondary batteries not to be shifted or deformed. Therefore, there is proposed a battery system using battery blocks that are securely fixed using fixing components when a plurality of rectangular batteries are stacked (see, for example, Patent Document 2: JP-A-2010-157450).

A battery pack having a large capacity can be manufactured by electrically connecting a plurality of secondary batteries. In addition, it is possible to constitute a battery pack that can be easily carried and installed by stacking the secondary batteries and housing them as a unit in a casing.

The plurality of secondary batteries as a unit housed in the battery pack casing are coupled by electrically connecting the external terminals of the individual batteries. Therefore, it is preferred that even if an external force such as vibration is applied, the external terminals should not be displaced, and a relative position between the coupled secondary batteries should not be changed so as to maintain the stable position and state.

In addition, it is preferred to suppress expansion of each secondary battery when gas is generated, and to securely fix each secondary battery not to be deformed or shifted. It is preferred to prevent deformation or breakage of the external terminal portion and to prevent deformation of the united battery pack unit by secure fixing.

For this purpose, when the plurality of secondary batteries including the laminated electrode assembly are coupled to form the battery pack, it is preferred that each secondary battery should not be deformed, relative position between them should not be shifted when they are stacked and fixed, the housed electrode assemblies should not be shifted, and no breakage should occur in the terminals even if an external force such as vibration is applied.

### SUMMARY OF THE INVENTION

Therefore, in view of the above-mentioned problem, it is an object of the present invention to provide a secondary battery and a battery pack having a structure, in which when a plurality of secondary batteries having laminated electrode assemblies are stacked to constitute a battery pack, deformation of each secondary battery can be suppressed, the electrode assemblies are not shifted, and no breakage occurs in the terminals even if an external force such as vibration is applied.

In order to achieve the above-mentioned object, a secondary battery of the present invention includes an electrode assembly in which positive electrode plates and negative electrode plates are laminated via separators to form a plurality of layers, an encapsulating case in which the electrode assembly is housed and electrolytic solution is filled, external terminals provided to the encapsulating case, positive and negative collector terminal for electrically connecting the positive and negative electrode plates to the external terminals, and a lid member attached to the encapsulating case, in which anti-displacement members are disposed inside and outside the lid member so that at least parts of them are positioned symmetrically with respect to a surface of the lid member.

With this structure, because anti-displacement members are disposed at the same position inside and outside the lid member, when the secondary batteries are stacked, the secondary batteries can be stacked so that each secondary battery is not deformed, and that their positions are not shifted from each other. Therefore, it is possible to provide the secondary battery in which deformation of each secondary battery can be suppressed, electrode assemblies are not shifted, and no breakage occurs in terminals, even if an external force such as vibration is applied.

Further, in the secondary battery of the present invention having the above-mentioned structure, the electrode assembly is disposed so that a lamination surface thereof is parallel to a bottom surface of the encapsulating case, and the anti-displacement member is disposed at a middle portion of the upper surface so as to contact with an upper surface of the electrode assembly. With this structure, because the anti-displacement member contacts with the upper surface of the electrode assembly, the stacked secondary batteries can be fixed so that the electrode assembly of each secondary battery does not shifted. Therefore, even if an external force such as vibration is applied, the electrode assembly is not shifted, and no breakage occurs in terminals. In addition, because the middle portion of the electrode assembly is contacted, expansion of the electrode assembly can be also suppressed effectively.

Further, in the secondary battery of the present invention having the above-mentioned structure, the electrode assembly is disposed so that a lamination surface thereof is parallel to a bottom surface of the encapsulating case, and the anti-displacement members are disposed at four corners of the upper surface so as to contact with an upper surface of the electrode assembly. With this structure, because the anti-displacement members contact with the upper surface of the electrode assembly at the four corners, the stacked secondary batteries can be securely fixed so that the electrode assembly of each secondary battery is not shifted. Therefore, the electrode assembly is not shifted, and no breakage occurs in terminals even if an external force such as vibration is applied.

Further, in the secondary battery of the present invention having the above-mentioned structure, the electrode assembly is disposed so that a lamination surface thereof is parallel to a bottom surface of the encapsulating case, and the anti-displacement members are disposed at a middle portion and four corners of the upper surface so as to contact with an upper surface of the electrode assembly. With this structure, because the anti-displacement members contact with the upper surface of the electrode assembly at the middle portion and the four corners, the stacked secondary batteries can be securely fixed so that the electrode assembly of each secondary battery is not shifted. Therefore, even if an external force such as vibration is applied, the electrode assembly is not shifted, and no breakage occurs in terminals.

Further, in the secondary battery of the present invention having the above-mentioned structure, the lid member has a projected or recessed portion restricting a position to which the anti-displacement member is attached. With this structure, only by attaching the anti-displacement members to the projected or recessed portions at predetermined positions of the lid member, the same position in the stack direction of the stacked secondary batteries can be easily fixed.

Further, a battery pack of the present invention includes a plurality of stacked secondary batteries, each of which includes an electrode assembly in which positive electrode plates and negative electrode plates are laminated via separators to form a plurality of layers, an encapsulating case in which the electrode assembly is housed and electrolytic solution is filled, external terminals provided to the encapsulating case, positive and negative collector terminal for electrically connecting the positive and negative electrode plates to the external terminals, and a lid member attached to the encapsulating case, in which the external terminals of the secondary batteries are electrically connected to each other. The battery pack further comprises a battery pack casing for housing the secondary batteries that are stacked as a unit, and a fixing means for pressing the same position in the stack direction so as to press and fix all the secondary batteries as a unit.

With this structure, because the stacked secondary batteries are pressed and fixed at the same position in the stack direction, the pressing force is applied to all the secondary batteries uniformly. In addition, each of the secondary batteries is not excessively deformed by the pressing force. Therefore, it is possible to provide the battery pack in which the secondary batteries can be stacked and fixed so that each of them is not deformed, and their positions are not shifted from each other.

Further, in the battery pack of the present invention having the above-mentioned structure, the fixing means includes anti-displacement members disposed inside and outside the lid member so as to be symmetric with respect to a surface of the lid member, and a pair of upper and lower pressing members for pressing and sandwiching the lowest and the uppermost anti-displacement members of the stack. With this structure, fixing of the secondary battery and fixing of the electrode assembly can be performed simultaneously by the anti-displacement member and the pressing member for pressing the anti-displacement members integrally.

Further, in the battery pack of the present invention having the above-mentioned structure, the battery pack casing includes a bottom plate, side plates fixed to the bottom plate, and an upper plate fixed to the side plates with screws, and the pressing member includes a lower pressing member provided to the bottom plate, an upper pressing member provided to the upper plate, and a screwing means to fix the upper plate with screws so that the upper plate is pressed toward the bottom plate. With this structure, the plurality of secondary batteries are stacked and housed in the battery pack casing, and the upper plate is fixed with the screws. Thus, the fixing means for pressing and fixing all the secondary batteries as a unit can be formed. Therefore, by the process of assembling the plurality of secondary batteries in the battery pack casing, it is possible to constitute the battery pack in which the secondary batteries can be stacked and fixed so that each of them is not deformed, and their positions are not shifted from each other.

### BRIEF DESCRIPTION OF THE DRAWINGS

FIG. 1 is a cross sectional schematic diagram illustrating a first embodiment of a secondary battery according to the present invention.

FIG. 2A is a main part enlarged plan view of the first embodiment.

FIG. 2B is a main part enlarged plan view of a variation example of the first embodiment.

FIG. 3 is a schematic cross sectional view illustrating a structure of a battery pack according to the present invention.

FIG. 4 is a cross sectional schematic diagram illustrating a second embodiment of the secondary battery according to the present invention.

FIG. 5 is a cross sectional schematic diagram illustrating a third embodiment of the secondary battery according to the present invention.

FIG. 6A is a schematic plan view illustrating a fourth embodiment of the secondary battery according to the present invention.

FIG. 6B is a schematic side view of the fourth embodiment.

FIG. 7 is a cross sectional schematic diagram illustrating of a secondary battery according to a comparative example.

FIG. 8 is an explanatory diagram illustrating a state after a vibration test of a battery pack including the secondary batteries of the comparative example.

FIG. 9 is an exploded perspective view of the secondary battery.

FIG. 10 is an exploded perspective view of an electrode assembly of the secondary battery.

FIG. 11 is a perspective view of a completed product of the secondary battery.

FIG. 12 is a schematic cross sectional view of the electrode assembly.

### DETAILED DESCRIPTION OF THE PREFERRED EMBODIMENTS

Hereinafter, an embodiment of the present invention is described with reference to the attached drawings. In addition, the same components are denoted by the same numerals or symbols, and overlapping description is omitted.

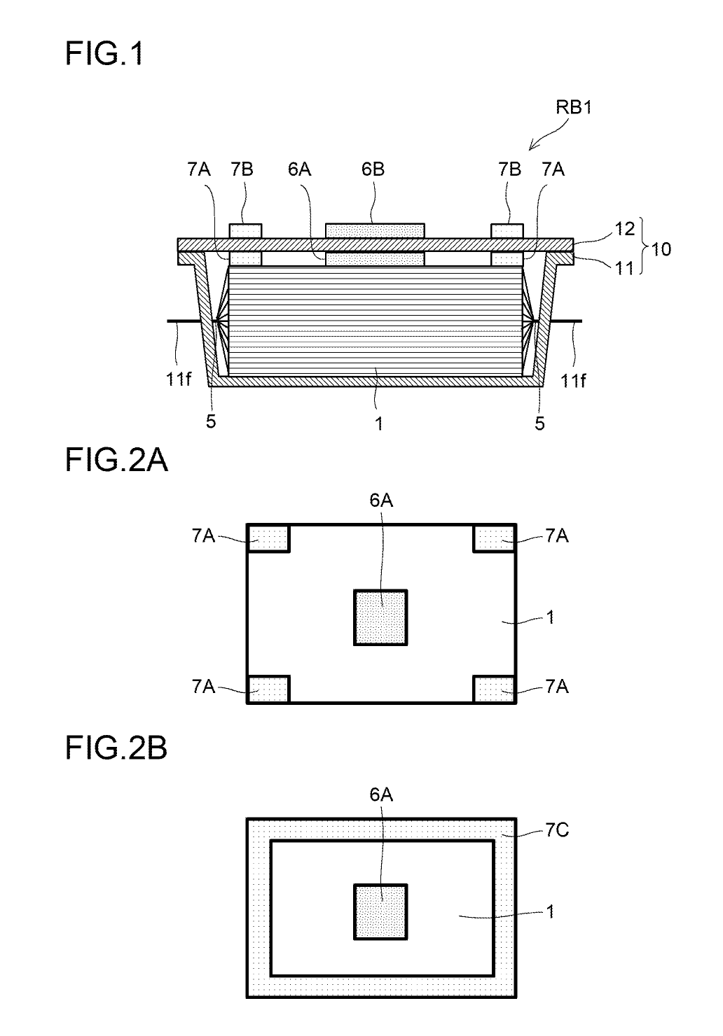

A lithium secondary battery is described as a secondary battery according to the present invention. For instance, a secondary battery RB1 according to this embodiment illustrated in FIG. 1 is a laminated lithium secondary battery including a laminated electrode assembly 1 in which positive electrode plates and negative electrode plates are laminated via separators to form a plurality of layers. In addition, the area of the electrode plate is increased, and the number of laminated layers is increased, so as to provide the secondary battery having relatively large capacity, which can be used as a storage battery for an electric vehicle or a storage battery for storing electric power.

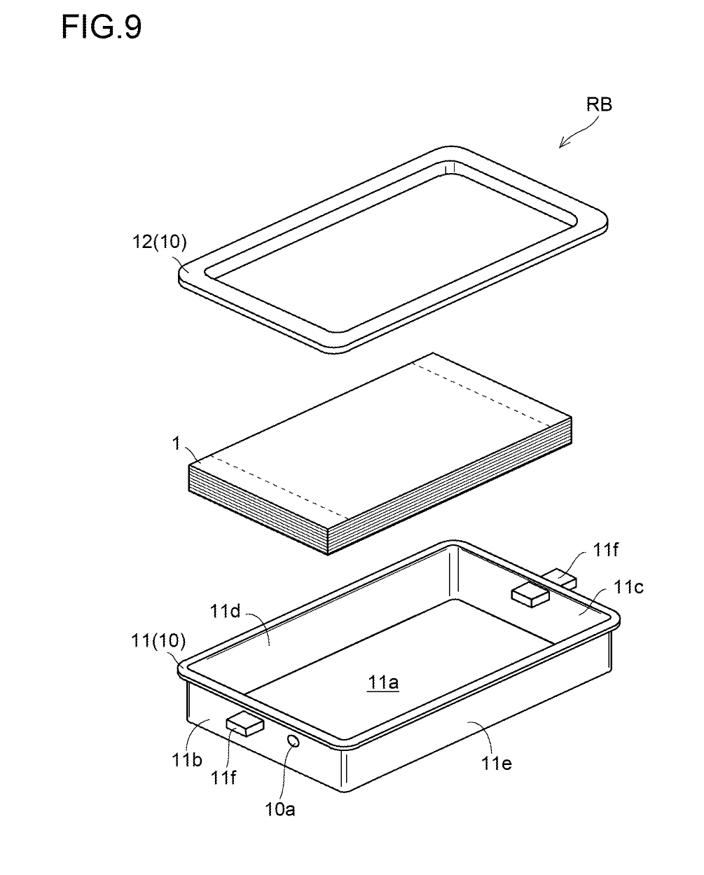

Next, specific structures of a laminated lithium secondary battery RB and the electrode assembly 1 are described with reference to FIGS. 9 to 12.

As illustrated in FIG. 9, the laminated lithium secondary battery RB has a rectangular shape in a plan view, and includes an electrode assembly 1 in which positive electrode plates, negative electrode plates, and separators are laminated, each of which has a rectangular shape. In addition, the electrode assembly 1 is housed in a battery can 10 constituted of an encapsulating case 11 including a bottom surface 11a and side surfaces 11b to 11e to have a box shape, and a lid member 12. Charging and discharging are performed using external terminals 11f disposed on side surfaces of the encapsulating case 11 (for example, two opposed side surfaces like the side surfaces 11b and 11c).

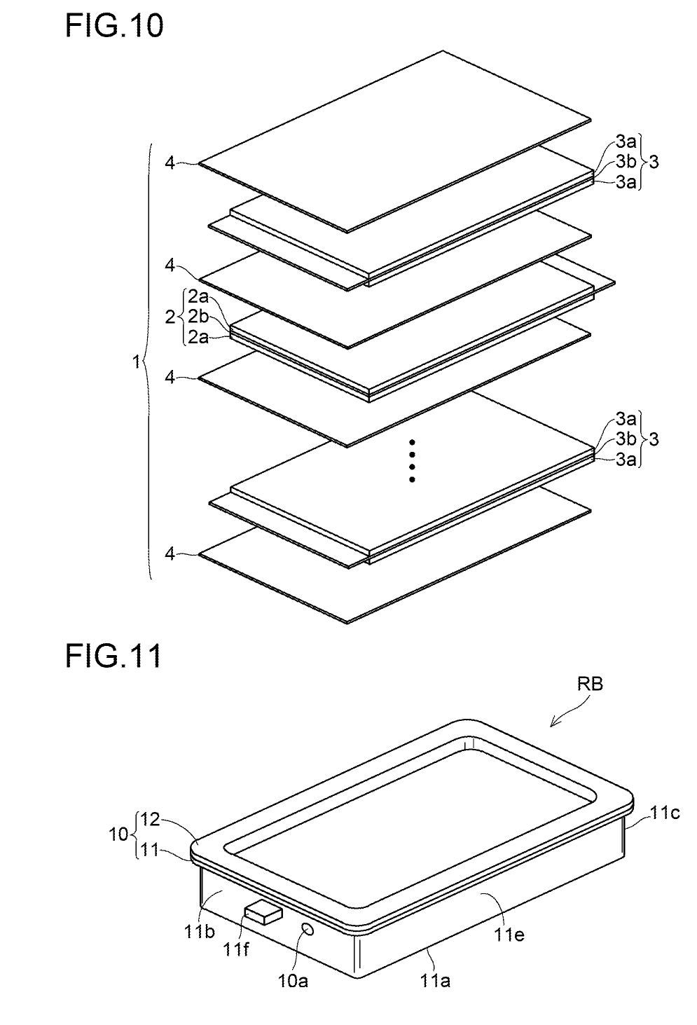

The electrode assembly 1 has a structure in which positive electrode plates and negative electrode plates are laminated via separators to form a plurality of layers. As illustrated in FIG. 10, positive electrode plates 2 and negative electrode plates 3 are laminated via separators 4. The positive electrode plate 2 includes positive electrode active material layers 2a made of positive electrode active material formed on both sides of a positive electrode collector 2b (for example, aluminum foil). The negative electrode plate 3 includes negative electrode active material layers 3a made of negative electrode active material formed on both sides of a negative electrode collector 3b (for example, copper foil).

The positive electrode plate 2 and the negative electrode plate 3 are insulated from each other by the separator 4, but lithium ions can move between the positive electrode plate 2 and the negative electrode plate 3 through electrolytic solution filled in the encapsulating case 11.

Here, as the positive electrode active material of the positive electrode plate 2, there are oxides containing lithium (such as LiCoO₂, LiNiO₂, LiFeO₂, LiMnO₂, and LiMn₂O₄), and compounds of the oxides in which a part of the transition metal is replaced by other metal element. In particular, by using the material such that 80% or higher of lithium contained in the positive electrode plate 2 can be used for battery reaction as the positive electrode active material, security against an accident such as overcharge can be enhanced.

In addition, as the negative electrode active material of the negative electrode plate 3, a substance containing lithium or a substance in which lithium can be inserted and removed is used. In particular, in order to achieve high energy density, it is preferred to use a material in which a potential for inserting or removing lithium is close to deposition/dissolution potential of the metal lithium. A typical example thereof is a particulate (scale-like, massive, fibrous, whisker, spherical, or crushed particulate) natural graphite or human-made graphite.

Note that in addition to the positive electrode active material of the positive electrode plate 2, or in addition to the negative electrode active material of the negative electrode plate 3, conductive material, thickening agent, integrity, and the like may be contained. The conductive material is not limited to a specific material as long as it is an electron conductive material that does not badly affect battery performance of the positive electrode plate 2 or the negative electrode plate 3. For instance, carbonaceous material such as carbon black, acetylene black, ketjen black, graphite (natural graphite or human-made graphite), or carbon material such as carbon fiber, or conductive metal oxide can be used.

As the thickening agent, for example, polyethylene glycols, celluloses, polyacrylamides, poly-N-vinylamides, poly-N-vinylpyrrolidones or the like can be used. The integrity has a role to combine active material particles and conductive material particles. As the integrity, there can be used fluorine polymer such as polyvinylidene fluoride, polyvinylpyridine, or polytetrafluoroethylene, or polyolefin polymer such as polyethylene or polypropylene, or styrene-butadiene rubber.

In addition, as the separator 4, it is preferred to use a micro-porous high-polymer film. Specifically, it is possible to use a film made of polyolefin high polymer such as nylon, cellulose acetate, nitrocellulose, polysulfone, polyacrylonitrile, polyvinylidene fluoride, polypropylene, polyethylene, polybutene, or the like.

In addition, as the electrolytic solution, it is preferred to use organic electrolytic solution. Specifically, as an organic solvent of the organic electrolytic solution, it is possible to use esters such as ethylene carbonate, propylene carbonate, butylene carbonate, diethyl carbonate, dimethyl carbonate, methylethyl carbonate, γ-butyrolactone, or the like, ethers such as tetrahydrofuran, 2-methyl tetrahydrofuran, dioxane, dioxolane, diethyl ether, dimethoxyethane, diethoxyethane, methoxyethane, or the like, and further to use dimethyl sulfoxide, sulfolane, methyl sulfolane, acetonitrile, methyl formate, methyl acetate, or the like. Note that each of these organic solvents can be used by itself, or two or more of them can be used as a mixture.

Further, the organic solvent may contain electrolyte salt. As the electrolyte salt, there are lithium salts such as lithium perchlorate (LiClO₄), lithium fluoroborate, lithium hexafluoride phosphate, trifluoromethane sulfonic acid (LiCF₃SO₃), lithium fluoride, lithium chloride, lithium bromide, lithium iodide, lithium aluminate tetrachloride, and the like. Note that each of these electrolyte salts can be used by itself, or two or more of them can be used as a mixture.

The concentration of the electrolyte salt is not limited to a specific value, but approximately 0.5 to 2.5 mol/L is preferable, and approximately 1.0 to 2.2 mol/L is more preferable. Note that if the concentration of the electrolyte salt is lower than approximately 0.5 mol/L, carrier concentration in the electrolytic solution may be decreased so that resistance of the electrolytic solution may be increased. On the other hand, if the concentration of the electrolyte salt is higher than approximately 2.5 mol/L, dissociation degree of the salt itself may be decreased so that carrier concentration in the electrolytic solution cannot be increased.

The battery can 10 includes the encapsulating case 11 and the lid member 12, which are made of iron, nickel-plated iron, stainless steel, aluminum, or the like. In addition, in this embodiment, as illustrated in FIG. 11, the battery can 10 is formed to have an outside shape that is a substantially flat rectangular shape when the encapsulating case 11 and the lid member 12 are combined.

The encapsulating case 11 has a box shape with the substantially rectangular bottom surface 11a and four side surfaces 11b to 11e rising from the bottom surface 11a, and in this box-shaped space there is housed the electrode assembly 1. The electrode assembly 1 has a positive electrode collector terminal connected to collector tabs of the positive electrode plates and a negative electrode collector terminal connected to collector tabs of the negative electrode plates. Further, external terminals 11f connected electrically to the collector tabs are disposed on side surfaces of the encapsulating case 11, respectively. The external terminals 11f are disposed at two positions of two opposed side surfaces 11b and 11c, for example. In addition, 10a denotes a liquid inlet from which the electrolytic solution is injected.

The electrode assembly 1 is housed in the encapsulating case 11, and the collector terminals are connected to the external terminals, respectively. Alternatively, the external terminals are connected to the collector terminals of the electrode assembly 1, respectively, the electrode assembly 1 is housed in the encapsulating case 11, and the external terminals are fixed to predetermined positions of the encapsulating case. After that, the lid member 12 is fixed to an opening rim of the encapsulating case 11. Then, the electrode assembly 1 is sandwiched and held between the bottom surface 11a of the encapsulating case 11 and the lid member 12, so that the electrode assembly 1 is retained in the battery can 10. Note that the lid member 12 is fixed to the encapsulating case 11 by means of laser beam welding or the like, for example. In addition, the collector terminal and the external terminal can be connected by using conductive adhesive or the like instead of welding such as ultrasonic welding, laser beam welding, or resistance welding.

As described above, the laminated secondary battery according to this embodiment has the structure including the electrode assembly 1 in which the positive electrode plates 2 and the negative electrode plates 3 are laminated via the separators 4 to form a plurality of layers, the encapsulating case 11 that houses the electrode assembly 1 and is filled with the electrolytic solution, the external terminals 11f provided to the encapsulating case 11, the positive and negative collector terminals for electrically connecting the positive and negative electrode plates and the external terminals 11f, and the lid member 12 fixed to the encapsulating case 11.

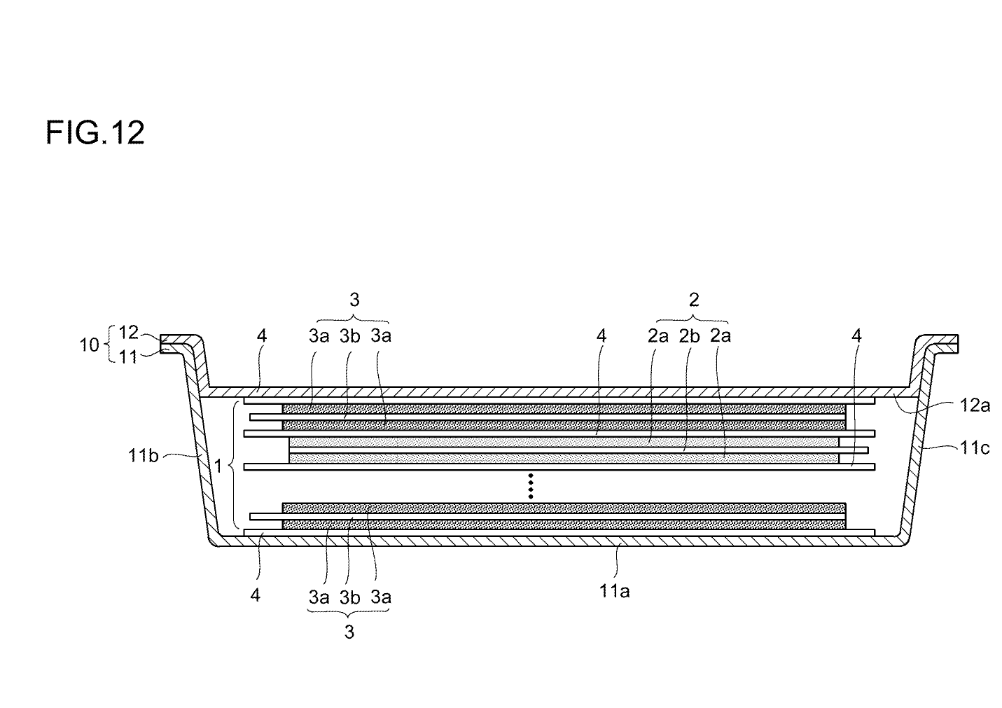

The electrode assembly 1 housed in the encapsulating case 11 includes, for example, as illustrated in FIG. 12, the positive electrode plates 2 in each of which the positive electrode active material layers 2a are formed on both sides of the positive electrode collector 2b, the negative electrode plates 3 in each of which the negative electrode active material layers 3a are formed on both sides of the negative electrode collector 3b, which are laminated via the separators 4, and further the separators 4 on both end surfaces. In addition, instead of the separator 4 on both end surfaces, a resin film made of the same material as the separator 4 may be wound so that the electrode assembly 1 is covered with the insulating resin film. In any case, a member having permeability for the electrolytic solution and insulating property is laminated on the upper surface of the laminated electrode assembly 1. Therefore, the surface can directly contact with the lid member 12 and can be pressed by the lid member 12 at a predetermined pressure.

This lid member 12 may be a flat plate or may not be a flat plate but may have a dish-like shape fitting in the can. If the dish-like lid member is used, movement in the work of welding the lid member can be prevented so that the welding work can be facilitated. In addition, by changing the sink amount of the dish shape, it is possible to easily respond to a variation of thickness of the housed electrode assembly.

In addition, if the battery can 10 is increased for larger capacity and the thickness of the electrode assembly 1 is also increased, risk of deformation or breakage of the collector terminal or the external terminal is increased due to shift of the electrode assembly 1 in the battery can when an external force such as vibration is applied. In particular, when a plurality of secondary batteries are stacked and external terminals thereof are electrically connected so as to constitute a battery pack, it is preferred that the terminal portions to be connected should not be deformed or broken.

Therefore, in this embodiment, the secondary battery has a structure in which when a plurality of secondary batteries including the laminated electrode assembly are stacked to form the battery pack, deformation of each secondary battery can be controlled, and even if an external force such as vibration is applied, the electrode assembly is not shifted, and no breakage occurs in the terminals.

Next, a first embodiment of a specific secondary battery is described with reference to FIGS. 1 to 3.

The secondary battery RB1 of the first embodiment illustrated in FIG. 1 is a laminated secondary battery including the electrode assembly 1 in which the positive electrode plates and negative electrode plates are laminated via separators to form a plurality of layers, the encapsulating case 11 that houses the electrode assembly 1 and filled with the electrolytic solution, the external terminals 11f provided to the encapsulating case 11, positive and negative collector terminals 5 that electrically connect the positive and negative electrode plates with the external terminals, and the lid member 12 that is attached to the encapsulating case 11. In addition, on the inside and the outside of the lid member 12, there are disposed anti-displacement members so that at least a part of them become symmetric with respect to a surface of the lid member 12.

The anti-displacement member includes a first anti-displacement member 6A that is disposed in the middle portion of the upper surface of the electrode assembly 1 so as to contact with the upper surface, for example. In addition, a first anti-displacement member 6B is disposed on the outside of the lid member 12 to be opposed to the first anti-displacement member 6A.

In addition, the anti-displacement member includes second anti-displacement members 7A that are disposed on four corners of the upper surface of the electrode assembly 1 so as to contact with the upper surface, for example. In addition, a second anti-displacement member 7B is disposed on the outside of the lid member 12 to be opposed to the second anti-displacement member 7A.

The first anti-displacement members 6A and 6B, or the second anti-displacement members 7A and 7B may have the same size or different sizes. It is sufficient if at least parts of them are disposed symmetrically with respect to a surface of the lid member 12. Because at least parts of them are disposed symmetrically with respect to a surface of the lid member 12 in this way, when the secondary batteries are stacked, the parts are overlapped in the vertical direction. Therefore, it is possible to stack the secondary batteries so that they are not deformed and are not shifted from each other.

As illustrated in FIG. 2A, the first anti-displacement member 6A has a rectangular plate-like shape in a top view disposed in the middle portion of the upper surface of the electrode assembly 1, for example. In addition, the second anti-displacement member 7A has a rectangular plate-like shape in a top view disposed at each of four corners of the upper surface of the electrode assembly 1. In addition, as this anti-displacement member, insulating foam (for example, polyethylene foam) is used. In particular, polyethylene foam is superior in mechanical strength and chemical resistance, and further in heat resistance, so it is suitable for the anti-displacement member used in this embodiment.

These first and second anti-displacement members may be used independently or may be used simultaneously. With the structure having such the anti-displacement member, because the anti-displacement member contacts with the upper surface of the electrode assembly 1, it is possible to fix the electrode assemblies 1 of the secondary batteries RB1 stacked vertically so that they are not shifted. Therefore, even if an external force such as vibration is applied, the electrode assemblies 1 are not shifted, and no breakage occurs in the terminals. In addition, with the structure in which the middle portion of the electrode assembly 1 is pressed, expansion of the electrode assembly 1 can also be suppressed effectively.

In addition, the lid member 12 is attached to the encapsulating case 11 so as to constitute the battery can 10. This lid member 12 can be like a flat plate as illustrated in the diagram or may be a dish-like shape having a portion contacting with the upper surface of the electrode assembly 1 that protrudes to form a protrusion engaging with the encapsulating case 11. The shape is appropriately selected in accordance with a size of the battery can 10 and thickness of the electrode assembly 1. In any case, it is possible to press and fix the electrode assembly 1 appropriately with the lid member 12 and the first and second anti-displacement members disposed on the inside and the outside of the lid member 12, so that the electrode assemblies 1 are not shifted.

In addition, as a variation example illustrated in FIG. 2B, it is possible to dispose a rectangular frame-like second anti-displacement member 7C along the periphery of the electrode assembly 1 instead of the second anti-displacement members 7A disposed at four corners of the upper surface of the electrode assembly 1. In this case, the second anti-displacement members 7B disposed at four corners of the outside of the lid member 12 need not to change.

In this structure, it is possible to dispose the anti-displacement members on the inside and the outside of the lid member 12 so that at least parts of them are disposed symmetrically with respect to a surface of the lid member 12. Therefore, when the secondary batteries RB1 are stacked to constitute the battery pack, it is possible to stack and fix them so that at least parts of inside members and outside members of the single batteries are overlapped in the vertical direction, and that the secondary batteries are not deformed and are not shifted from each other.

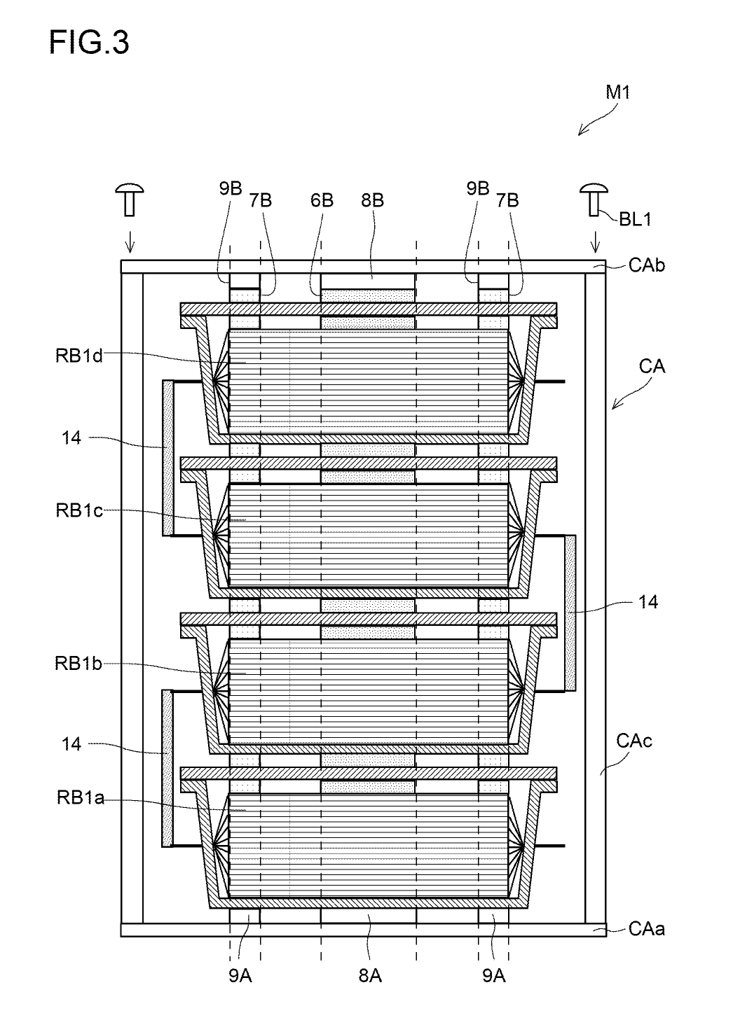

Next, a battery pack M1 constituted by stacking a plurality of the secondary batteries RB1 is described with reference to FIG. 3.

The secondary batteries RB1 to which the anti-displacement members are attached at the same position are stacked vertically and housed in a battery pack casing CA having a bottom plate CAa, an upper plate CAb, and side plates CAc.

For instance, the upper plate CAb is fixed to the side plates CAc with screws. Therefore, the secondary batteries RB1 are stacked inside the battery pack casing CA in the state where the upper plate CAb is removed. Alternatively, a battery unit of the secondary batteries RB1 stacked in advance is attached inside the battery pack casing CA. Then, the upper plate CAb is attached and fixed with fixing screws BL1.

In this case, lower pressing members 8A and 9A are disposed on the bottom plate CAa at positions corresponding to positions of the anti-displacement members attached to the lowermost secondary battery RB1a, and upper pressing members 8B and 9B are disposed on the upper plate CAb at positions corresponding to positions of the anti-displacement members attached to the uppermost secondary battery RB1d. In addition, the lower pressing member 8A and the upper pressing member 8B are disposed corresponding to the above-mentioned first anti-displacement members 6A and 6B, while the lower pressing members 9A and the upper pressing members 9B are disposed corresponding to the above-mentioned second anti-displacement members 7A and 7B.

In other words, by operation of fixing the upper plate CAb with screws, the lower pressing member 8A and the upper pressing member 8B press and sandwich the first anti-displacement members 6A and 6B of the stacked secondary batteries RB1a to RB1d so as to retain the same. In addition, the lower pressing members 9A and the upper pressing members 9B press and sandwich the second anti-displacement members 7A and 7B of the secondary batteries RB1a to RB1d so as to retain the same.

As described above, the battery pack casing CA include the bottom plate CAa, the side plates CAc fixed to the bottom plate CAa, and the upper plate CAb fixed to the side plates CAc with screws. The pressing members includes the lower pressing members 8A and 9A disposed on the bottom plate CAa, the upper pressing members 8B and 9B disposed on the upper plate CAb, and a screwing means to fix the upper plate CAb with screws so that the upper plate CAb is pressed toward the bottom plate CAa.

With this structure, a plurality of secondary batteries RB1 are stacked and housed in the battery pack casing CA, and the upper plate CAb is fixed with screws. Thus, as illustrated by vertical broken lines in the diagram, the middle portion corresponding to the first anti-displacement member 6B is sandwiched between the lower pressing member 8A and the upper pressing member 8B, while the portions corresponding to the second anti-displacement members 7B are sandwiched between the lower pressing members 9A and the upper pressing members 9B. Thus, it is possible to constitute a fixing means for pressing and fixing all the secondary batteries RB1a to RB1d as a unit.

Therefore, it is possible to constitute the battery pack M1 in which when the plurality of secondary batteries are put in the battery pack casing as a unit, they can be stacked and fixed so that each of them is not deformed, and they are not shifted from each other. In other words, the battery pack M1 has a structure including the battery pack casing CA housing the stacked secondary batteries RB1 as a unit, and the fixing means for pressing and fixing all the secondary batteries RB1 (RB1a to RB1d) as a unit by uniformly pressing the same position in the stacking direction.

Therefore, the fixing means of this embodiment includes the anti-displacement members (the first anti-displacement members 6A and 6B, and the second anti-displacement members 7A and 7B) disposed on the inside and the outside of the lid member 12 so that at least parts of them are positioned symmetrically with respect to the lid member surface, and the pair of upper and lower pressing members (the lower pressing members 8A and 9A and the upper pressing members 8B and 9B) that press and sandwich the stacked lowest anti-displacement member and uppermost anti-displacement member. With this structure, as illustrated by the vertical broken lines in the diagram, fixing of the secondary batteries RB1 and fixing of the electrode assemblies 1 can be performed simultaneously by the anti-displacement members and the pressing members that press the anti-displacement members as a unit.

In other words, a pressing force is applied effectively in the stack height direction so that a shift of the stacked secondary batteries (single batteries) in the plane direction can be suppressed effectively, and displacement in the height direction (expansion of the lid member) can also be suppressed effectively.

In addition, in this embodiment, because the anti-displacement member having insulating property is disposed on the upper side of the lid member 12, insulation between the batteries can be secured. In addition, because a gap is secured between them, heat dispersion effect is also obtained.

The anti-displacement members may be disposed at appropriate positions depending on a size of the secondary battery RB1. For instance, as described above, it is possible to dispose only the first anti-displacement members 6A and 6B pressing the middle portion of the electrode assembly 1, or it is possible to dispose only the second anti-displacement members 7A and 7B pressing four corners of the electrode assembly 1, or it is possible to dispose both of them.

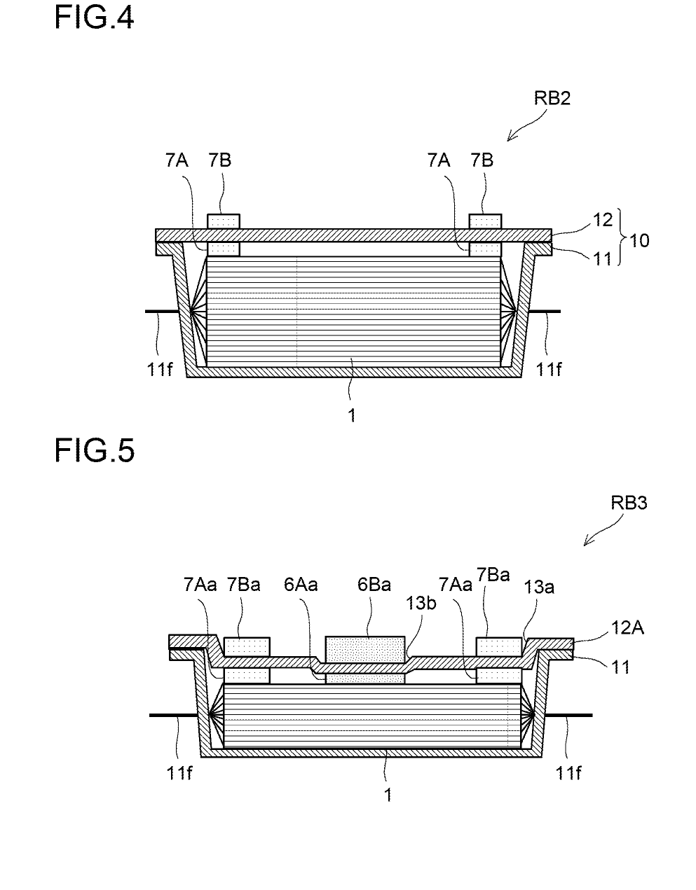

For instance, like a secondary battery RB2 of a second embodiment illustrated in FIG. 4, it is possible to dispose only the second anti-displacement members 7A and 7B pressing four corners of the electrode assembly 1, to stack a plurality of the secondary batteries RB2, and to house the same in the casing so as to constitute the battery pack.

With this structure too, because the anti-displacement members (second anti-displacement members 7A and 7B) contact with the four corners of the upper surface of the electrode assembly 1, it is possible to fix the electrode assemblies 1 of the secondary batteries RB2 stacked vertically so that they are not shifted. Therefore, even if an external force such as vibration is applied, the electrode assembly 1 is not shifted, and no breakage occurs in the terminals.

In addition, the lid member 12 may have a projected or recessed portion restricting an attaching position of the anti-displacement member. For instance, like a secondary battery RB3 of a third embodiment illustrated in FIG. 5, a lid member 12A has a dish-like shape in which the portion contacting with the upper surface of the electrode assembly 1 protrudes to form a protrusion fitting in the encapsulating case 11, second anti-displacement members 7Ba are attached to a first recess 13a, and a first anti-displacement member 6Ba is attached to a second recess 13b formed in the middle portion.

With this structure, the first and the second recesses are disposed at predetermined positions corresponding to the first anti-displacement member 6A and the second anti-displacement member 7A disposed on the inside of the lid member 12A. Thus, only by attaching the anti-displacement members (the first anti-displacement member 6Ba and the second anti-displacement member 7Ba) to the projected or recessed portion formed at the predetermined positions of the lid member, the same position in the stack direction of the secondary batteries RB3 stacked vertically can be easily fixed.

Further, in addition to the first anti-displacement member 6A for pressing and fixing in the stack height direction, it is possible to dispose a third anti-displacement member for suppressing a shift of the electrode assembly 1 in a lateral direction, so that a shift of the electrode assembly 1 can be effectively suppressed.

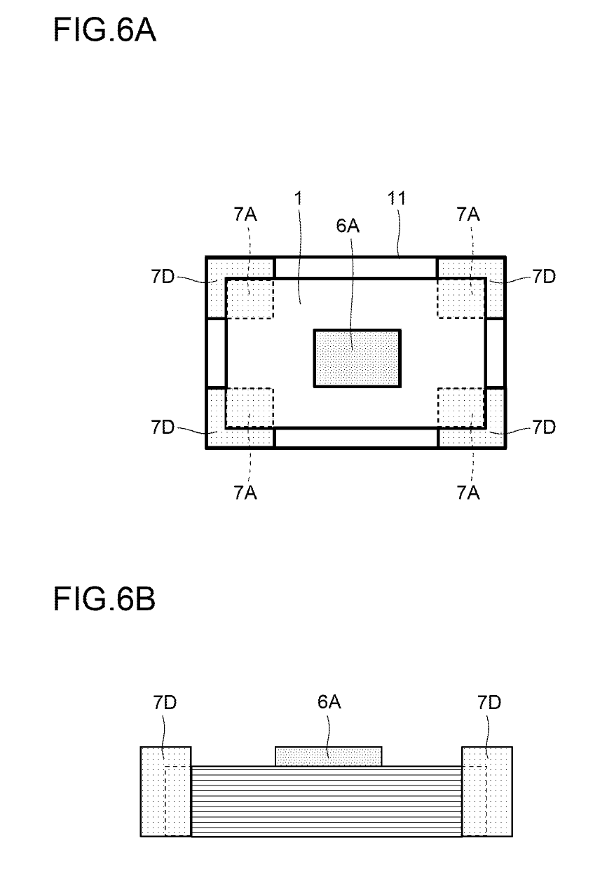

For instance, like a fourth embodiment illustrated in FIG. 6A, in addition to the first anti-displacement member 6A, there are disposed third anti-displacement members 7D having an L-shape in a plan view between the electrode assembly 1 and the encapsulating case 11 at four corners of the electrode assembly 1. The third anti-displacement member 7D has a block-like shape having a height that is approximately the height of the electrode assembly 1 plus the thickness of the first anti-displacement member 6A as illustrated in FIG. 6B. This member is also made of the above-mentioned polyethylene foam.

With this structure too, it is possible to securely fix the stacked secondary batteries so that the electrode assemblies 1 of them are not shifted. Therefore, even if an external force such as vibration is applied, the electrode assemblies 1 are not shifted, and no breakage occurs in the terminals as an appropriate structure.

In this case, as illustrated by the broken line in FIG. 6A, together with the third anti-displacement members 7D, the second anti-displacement members 7A may be used at the four corners of the upper surface of the electrode assembly 1. In addition, the first anti-displacement member 6B and the second anti-displacement member 7B may be disposed also on the backside of the bottom of the encapsulating case 11.

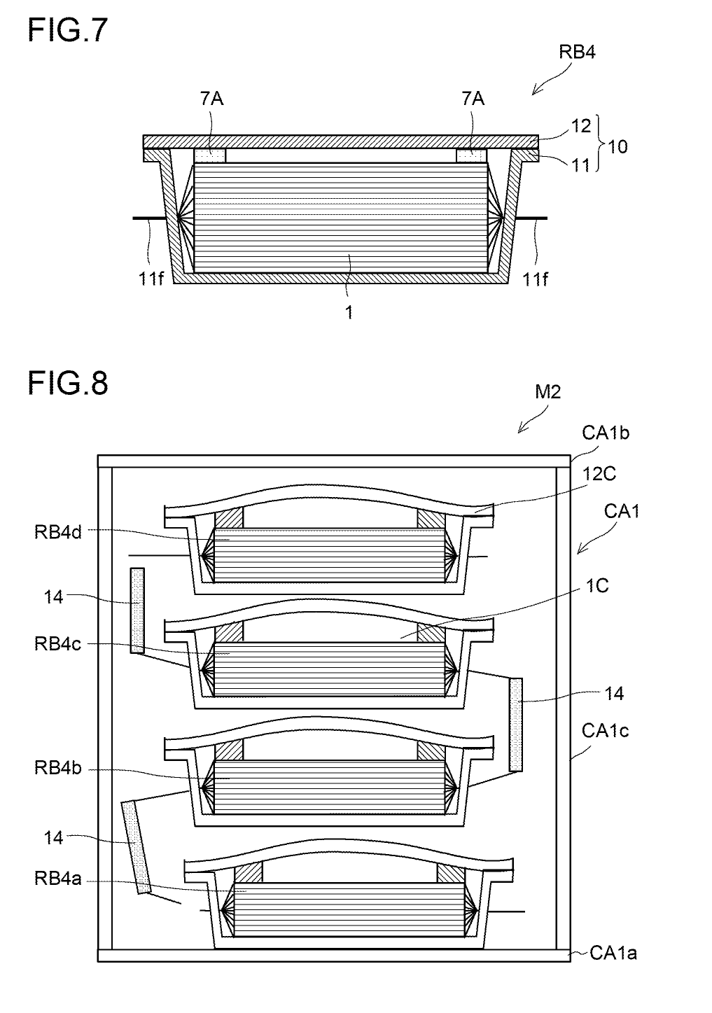

For instance, a secondary battery RB4 of a comparative example illustrated in FIG. 7 is considered, which has a structure without the anti-displacement member outside the lid member 12. If a plurality of the secondary batteries RB4 are simply stacked and housed in a casing, so as to constitute a battery pack without using the fixing means, expansion of the lid member of each secondary battery cannot be suppressed effectively, and shift of the electrode assembly 1 cannot be prevented too.

As illustrated in FIG. 8, a plurality of the secondary batteries RB4 are stacked and housed in a battery pack casing CA1 having a bottom plate CA1a, an upper plate CA1b, and side plates CA1c without the fixing means to constitute a battery pack M2. When the battery pack M2 is vibrated, a positional shift is generated among the secondary batteries RB4 (RB4a to RB4d), connection between the connection terminal 14 and the external terminal is broken, or the connection terminal 14 is deformed. In addition, expansion of a lid member 12C of each of the secondary batteries RB4 (RB4a to RB4d) cannot be suppressed as a problem.

Next, a lithium secondary battery that is actually manufactured is described.

### EXAMPLES

### Manufacture of Positive Electrode Plates

LiFePO4 (90 part by weight) as the positive electrode active material, acetylene black (5 part by weight) as the conductive material, and polyvinylidene fluoride (5 part by weight) as the integrity were mixed, and N-methyl-2-pyrrolidone as the solvent was added appropriately so that the materials were dispersed so as to prepare slurry. This slurry was applied uniformly onto both surfaces of aluminum foil (having a thickness of 20 μm) as the positive electrode collector and was dried. Then, it was compressed by a roll press and was cut at a predetermined size so as to make the plate-like positive electrode plate 2.

In addition, the made positive electrode plate had a size of 140 mm×250 mm, and a thickness of 230 μm. Seventy positive electrode plates 2 were used.

[Manufacture of Negative Electrode Plates]

Natural graphite (90 part by weight) as the negative electrode active material, and polyvinylidene fluoride (10 part by weight) as the integrity were mixed, and N-methyl-2-pyrrolidone as the solvent was added appropriately so that the materials were dispersed so as to prepare slurry. This slurry was applied uniformly onto both surfaces of copper foil (having a thickness of 16 nm) as the negative electrode collector and was dried. Then, it was compressed by the roll press and was cut at a predetermined size so as to make the plate-like negative electrode plate 3.

In addition, the made negative electrode plate had a size of 142 mm×255 mm, and a thickness of 146 nm. Seventy-one negative electrode plates 3 were used.

In addition, as the separators, 140 polyethylene films were prepared, each of which had a size of 145 mm×255 mm and a thickness of 25 nm.

[Manufacture of Nonaqueous Electrolytic Solution]

Ethylene carbonate (EC) and diethyl carbonate (DEC) were mixed at a volume ratio of 30:70 to make mixed liquid (solvent), in which LiPF₆ was dissolved at 1 mol/L so as to prepare the nonaqueous electrolytic solution.

[Manufacture of Battery Can]

The encapsulating case and the lid member constituting the battery can were made of nickel plated steel sheet. In addition, each of them has a thickness of 0.8 mm. Inner dimensions of the battery can were as follows. The longitudinal length was 320 mm, the short length was 150 mm, and the depth was 40 mm. Thus, a rectangular lithium secondary battery with an openable/closable inlet plug was manufactured. In addition, a plate-like lid member was used.

[Assembly of Secondary Battery]

The positive electrode plates and the negative electrode plate were laminated alternately via the separators. In this case, 70 positive electrode plates, 71 negative electrode plates, and 140 separators were laminated so that the negative electrode plates were positioned outside the positive electrode plates. Around this laminated body, polyethylene film having the same thickness of 25 nm as the separator is wound, so that the electrode assembly (laminated body) having a thickness of approximately 30 mm was made.

The size of the separator disposed between the positive and negative electrode plates is 145 mm×255 mm as described above, which is a little larger than the positive electrode plate (140×250) and the negative electrode plate (142×255). Thus, the active material layers formed on the positive electrode plates and the negative electrode plates are securely covered. In addition, connection pieces of collector members (collector terminals) were connected to a collector exposed portion of the positive electrode and a collector exposed portion of the negative electrode.

As the anti-displacement members, polyethylene foams having a size of 56 mm×102 mm×12 mm (thickness) corresponding to the first anti-displacement members 6A and 6B, and polyethylene foams having a size of 28 mm×51 mm×12 mm (thickness) corresponding to the second anti-displacement members 7A and 7B were used. In addition, adhesive (that is not corrosive to the electrolytic solution, for example, BM-140S produced by ZEON CORPORATION) was used for attaching the anti-displacement members to the lid member.

The electrode assembly to which the collector terminals were connected was housed in the encapsulating case, the collector terminals were connected to the external terminals, the anti-displacement member were placed, the lid member were attached and sealed, and the nonaqueous electrolytic solution was filled through a liquid inlet under a reduced pressure. After filling the liquid, the liquid inlet was sealed. Five secondary batteries were manufactured for each embodiment. In addition, the battery pack casing was made using galvanized steel sheet having a thickness of 10 mm, in which five secondary batteries were stacked, and the connection terminals were assembled and united to constitute the battery pack.

Example 1 is an example in which five secondary batteries corresponding to the secondary batteries RB1 of the first embodiment are used to constitute the battery pack. The middle portion and the four corners of the electrode assembly 1 are pressed. Example 2 is an example in which five secondary batteries corresponding to the secondary battery RB2 of second embodiment are used to constitute the battery pack. The four corners of the electrode assembly 1 are pressed.

The comparative example is an example in which five secondary batteries corresponding to the secondary battery RB4 described above are used to constitute the battery pack. The middle portion and the four corners of the electrode assembly 1 are not pressed.

A vibration test was performed using the battery packs of Examples 1 and 2, and the comparative example, so as to check shifts of the secondary batteries, deformation of the lid member, and breakage state of the terminals. A result of this experiment is shown in Table 1.

TABLE 1

| | ANTI- | | NUMBER OF | |
|---|---|---|---|---|
| | DISPLACEMENT | NUMBER OF | GOOD | |
| | MEMBER | SAMPLES | SAMPLES | RESULT OF CONFIRMATION |
| EXAMPLE 1 | MIDDLE | 5 | 5 | NO SHIFT, NO EXPANSION |
| | PORTION + | | | OF LID, NO DEFORMATION |
| | FOUR CORNERS | | | OR BREAKAGE OF |
| | | | | TERMINALS |
| EXAMPLE 2 | FOUR | 5 | 5 | NO SHIFT, SMALL EXPANSION |
| | CORNERS | | | OF LID, NO DEFORMATION |
| | | | | OR BREAKAGE OF |
| | | | | TERMINALS |
| COMPARATIVE | NONE | 5 | 1 | GOOD SAMPLE HAS NO |
| EXAMPLE 1 | | | | DEFORMATION OR BREAKAGE |
| | | | | OF TERMINALS DEFECTIVE |
| | | | | SAMPLE HAS SHIFT, SMALL |
| | | | | EXPANSION OF LID, AND |
| | | | | DEFORMATION OR BREAKAGE |
| | | | | OF TERMINALS |

The vibration test was performed in three axes directions (x axis, y axis, and z axis) for 3 hours and 45 minutes in each direction (total 11 hours and 15 minutes). In addition, the vibration frequency was varied from 5 Hz to 200 Hz and back to 5 Hz with the acceleration varied from 1 G to 8 G and back to 1 G. One set of 15 minutes test was repeated 15 times (corresponding to 3 hours 45 minutes).

As a result of the vibration test, in Example 1 (corresponding to the first embodiment), there was no shift in the plane direction of the stacked secondary batteries, there was no expansion of the lid member, and there was no deformation or breakage in the connection terminals. In Example 2 (corresponding to second embodiment), there was no shift in the plane direction of the stacked secondary battery, but there was a small expansion of the lid member. However, there was no deformation or breakage in the connection terminals, and hence the battery pack was normal.

However, in Comparative Example 1 without the anti-displacement member, there were abnormalities in four out of five sample batteries, and each of them has an expansion of the lid, and deformation or breakage of the connection terminal.

As described above, according to the secondary battery with anti-displacement members of this embodiment, even in a large electrode assembly, in which the positive electrode plates, the negative electrode plates, and the separators are laminated to form a few tens of layers, because the anti-displacement members are disposed at the same positions inside and outside the lid member, when the secondary batteries are stacked, the secondary batteries are not deformed and can be stacked and fixed so that their positions are not shifted from each other.

Therefore, when a plurality of the secondary batteries are stacked, and the electrode assemblies and the lid member are pressed in the stack direction to be fixed for constituting the battery pack, the battery pack has a structure in which secondary batteries (single batteries) are not shifted, no breakage occurs in the connection terminals or the like, and no malfunction occurs, even if an external force such as vibration is applied.

As described above, according to the present invention, because the anti-displacement members are disposed at the same positions inside and outside the lid member, when the secondary batteries are stacked, the secondary batteries are not deformed and can be stacked and fixed so that their positions are not shifted from each other. Therefore, it is possible to provide the secondary battery and the battery pack in which the electrode assemblies are not shifted, and no breakage occurs in the terminals, even if an external force such as vibration is applied.

Therefore, the secondary battery and the battery pack according to the present invention can be used appropriately for a storage battery having a large capacity to which a large size and performance stability are required.

What is claimed is:

1. A secondary battery comprising:
an electrode assembly in which positive electrode plates and negative electrode plates are laminated via separators to form a plurality of layers;
an encapsulating case in which the electrode assembly is housed and electrolytic solution is filled;
external terminals provided to the encapsulating case;
positive and negative collector terminal for electrically connecting the positive and negative electrode plates to the external terminals; and
a lid member attached to the encapsulating case, wherein
anti-displacement members are disposed inside and outside the lid member so that at least parts of them are positioned symmetrically with respect to a surface of the lid member.

2. The secondary battery according to claim 1, wherein the electrode assembly is disposed so that a lamination surface thereof is parallel to a bottom surface of the encapsulating case, and the anti-displacement member is disposed at a middle portion of the upper surface so as to contact with an upper surface of the electrode assembly.

3. The secondary battery according to claim 1, wherein the electrode assembly is disposed so that a lamination surface thereof is parallel to a bottom surface of the encapsulating case, and the anti-displacement members are disposed at four corners of the upper surface so as to contact with an upper surface of the electrode assembly.

4. The secondary battery according to claim 1, wherein the electrode assembly is disposed so that a lamination surface thereof is parallel to a bottom surface of the encapsulating case, and the anti-displacement members are disposed at a middle portion and four corners of the upper surface so as to contact with an upper surface of the electrode assembly.

5. The secondary battery according to claim 1, wherein the lid member has a projected or recessed portion restricting a position to which the anti-displacement member is attached.

6. A battery pack comprising a plurality of secondary batteries, each of which includes:
an electrode assembly in which positive electrode plates and negative electrode plates are laminated via separators to form a plurality of layers;
an encapsulating case in which the electrode assembly is housed and electrolytic solution is filled;
external terminals provided to the encapsulating case;
positive and negative collector terminal for electrically connecting the positive and negative electrode plates to the external terminals; and
a lid member attached to the encapsulating case, wherein the external terminals of the secondary batteries are electrically connected to each other, and
the battery pack further comprises a battery pack casing for housing the secondary batteries that are stacked as a unit, and a fixing means for pressing the same position in the stack direction so as to press and fix all the secondary batteries as a unit.

7. The battery pack according to claim 6, wherein the fixing means includes anti-displacement members disposed inside and outside the lid member so as to be symmetric with respect to a surface of the lid member, and a pair of upper and lower pressing members for pressing and sandwiching the lowest and the uppermost anti-displacement members of the stack.

8. The battery pack according to claim 7, wherein the battery pack casing includes a bottom plate, side plates fixed to the bottom plate, and an upper plate fixed to the side plates with screws, and the pressing member includes a lower pressing member provided to the bottom plate, an upper pressing member provided to the upper plate, and a screwing means to fix the upper plate with screws so that the upper plate is pressed toward the bottom plate.
